(19) United States
(12) Patent Application Publication
(10) Pub. No.: US 2025/0259313 A1
(43) Pub. Date: Aug. 14, 2025

(54) SCALABLE CROSS-MODAL MULTI-CAMERA OBJECT TRACKING USING TRANSFORMERS AND CROSS-VIEW MEMORY FUSION

(71) Applicant: QUALCOMM Incorporated, San Diego, CA (US)

(72) Inventors: Varun Ravi Kumar, San Diego, CA (US); Kiran Bangalore Ravi, Paris (FR); Senthil Kumar Yogamani, Headford (IE)

(21) Appl. No.: 18/440,476

(22) Filed: Feb. 13, 2024

(51) Int. Cl. G06T 7/246; G06F 16/56; G06V 10/766; G06V 10/77; G06V 10/82; G06V 20/58

(52) U.S. Cl. CPC G06T 7/248; G06F 16/56; G06V 10/766; G06V 10/7715; G06V 10/82; G06V 20/58; G06T 2207/20081; G06T 2207/20084; G06T 2207/30252

(57) ABSTRACT

A method of object tracking includes detecting a dynamic object in a scene, sampling key points of the dynamic object, extracting short term features of the key points, combining long-term key point features read from a key point features database into combined key point features, applying attention processing to hash the combined key point features, applying a plurality of transformer layers on top of attention processing to update the combined key point features using the interactions of the key points to form the long-term key point features and storing the long-term key point features in the key point features database, and predicting an updated 3D box for the dynamic object from the updated combined key point features, the updated 3D box including a tracklet representing motion of the dynamic object in the scene over time.

### TECHNICAL FIELD

This disclosure relates to computer vision and object tracking.

### BACKGROUND

Autonomous vehicles and semi-autonomous vehicles may include an advanced driver assistance system (ADAS) using sensors and software to help operate the vehicles. An ADAS may use artificial intelligence (AI) and machine learning (ML) (e.g., deep neural network (DNN)) techniques for performing various operations for operating, piloting, and navigating the vehicles. For example, ML models may be used for object detection, object tracking, lane and road boundary detection, safety analysis, drivable free-space analysis, control generation during vehicle maneuvers, and/or other operations. ML model-powered autonomous and semi-autonomous vehicles should be able to respond properly to an incredibly diverse set of situations, including interactions with emergency vehicles, pedestrians, animals, and a virtually infinite number of other obstacles.

ML has revolutionized many aspects of computer vision. For example, the computer vision task of object tracking based on captured image data is useful for autonomous and semi-autonomous systems (such as autonomous and semi-autonomous vehicles), to perceive and navigate the surrounding environment. For example, object tracking may be used for collision avoidance processing. Estimating the movement of an object in image data by a ML model remains a challenging computer vision task.

### SUMMARY

This disclosure describes techniques and devices for performing motion prediction of objects in images of a scene captured by multiple cameras. An object motion predictor may detect objects in camera output images, sample key points of the objects, extract features of the key points, and combine short term and long-term key point features. The object motion predictor may apply a locality sensitive hashing (LSH) operation to hash the key point features into hash buckets, and then apply a plurality of transformer layers on top of the LSH attention to update key point features. The object motion predictor may augment the key point features with identifiers, and then predict updated three-dimensional (3D) boxes for the objects, including tracklets representing motion. Finally, the object motion predictor may train the model using regression loss from a loss function. The techniques of this disclosure improve video motion prediction by modeling correlations between point trajectories that originate from the same objects of the scene. This may help overcome object tracking problems relating to occlusions and improve overall object tracking accuracy.

In one example, this disclosure describes an apparatus for object tracking comprising a memory, and one or more processors implemented in circuitry and in communication with the memory. The one or more processors configured to detect a dynamic object in a scene captured in a plurality of camera output images by a plurality of cameras over time, sample key points of the dynamic object, extract short term features of the key points, combine long-term key point features read from a key point features database stored in a memory and the short term key point features into combined key point features, apply attention processing to hash the combined key point features into hash buckets representing interactions of the key points, apply a plurality of transformer layers on top of attention processing to update the combined key point features using the interactions of the key points to form the long-term key point features and storing the long-term key point features in the key point features database, and predict an updated 3D box for the dynamic object from the updated combined key point features, the updated 3D box including a tracklet representing motion of the dynamic object in the scene over time.

In another example, this disclosure describes a method of object tracking comprising: detecting a dynamic object in a scene captured in a plurality of camera output images by a plurality of cameras over time, sampling key points of the dynamic object, extracting short term features of the key points, combining long-term key point features read from a key point features database stored in a memory and the short term key point features into combined key point features, applying attention processing to hash the combined key point features into hash buckets representing interactions of the key points, applying a plurality of transformer layers on top of attention processing to update the combined key point features using the interactions of the key points to form the long-term key point features and storing the long-term key point features in the key point features database, and predicting an updated 3D box for the dynamic object from the updated combined key point features, the updated 3D box including a tracklet representing motion of the dynamic object in the scene over time.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example autonomous vehicle in accordance with the techniques of this disclosure.

FIG. 2 is a block diagram illustrating an example computing system that may perform the techniques of this disclosure.

FIG. 3 is a block diagram illustrating a system for performing object tracking in accordance with the techniques of this disclosure.

FIG. 4 is a flow diagram illustrating an example method for performing object tracking in accordance with the techniques of this disclosure.

FIG. 5 is a flow diagram illustrating another example method for performing object tracking in accordance with the techniques of this disclosure.

### DETAILED DESCRIPTION

Aspects of the present disclosure provide apparatuses, methods, computing systems and non-transitory computer-readable media for performing object tracking using transformers and cross-view memory fusion from monocular videos.

Object tracking in image data, which can be used for navigation processing, is a valuable task in computer vision applications. For example, object tracking is useful for determining collision avoidance for vehicles driving autonomously or semi-autonomously or with assistance, drones flying autonomously or semi-autonomously, warehouse or household robots operating autonomously or semi-autonomously, or for spatial scene understanding, and other examples.

Existing approaches to object tracking (also known as video motion prediction) typically estimate an overall optical flow between consecutive frames of video data received from one or more cameras or independently track the motion of individual points in the video data over time. However, independently tracking points fails to leverage correlations that may arise when points belong to the same physical object in a scene. This approach ignores useful correlation information and may negatively impact system performance. The computational complexity of some existing approaches scales quadratically (e.g., O(N²)) with the number of tracked points N due to using self-attention layers. This inhibits efficient performance when scaling up to dense tracking (e.g., tracking large numbers of objects in a scene) without using approximations, which may negatively affect object tracking accuracy. Further, these existing approaches do not explicitly account for complex background motion which also may negatively affect object tracking accuracy, and are trained on synthetic data, which is not suitable for 3D object detection (3DOD) and tracking of multiple objects.

The techniques of the present disclosure address various known object tracking problems to improve video motion prediction by modeling correlations between point trajectories that originate from the same objects of the scene. This may help overcome object tracking problems relating to occlusions and improve overall object tracking accuracy.

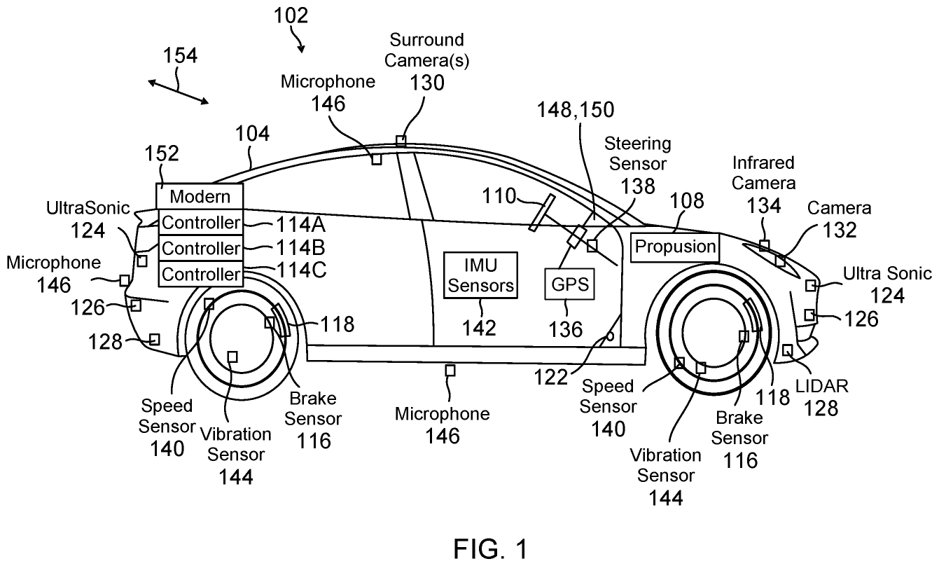

FIG. 1 is a diagram of an example autonomous vehicle, in accordance with the techniques of this disclosure. Autonomous vehicle 102 in the example shown may comprise any vehicle (such as a car, van or truck) that can accommodate a human driver and/or human passengers. Autonomous vehicle 102 may include a vehicle body 104 suspended on a chassis, in this example comprised of four wheels and associated axles.

A propulsion system 108, such as an internal combustion engine, hybrid electric power plant, or even all-electric engine, may be connected to drive some or all the wheels via a drive train, which may include a transmission (not shown). A steering wheel 110 may be used to steer some or all the wheels to direct autonomous vehicle 102 along a desired path when the propulsion system 108 is operating and engaged to propel the autonomous vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be one or more onboard computer systems that may be configured to perform deep learning, machine learning (ML), and/or artificial intelligence (AI) functionality and output autonomous operation commands to autonomous vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide AI functionality for in-camera sensors, and controller 114D (not shown in FIG. 1) may provide infotainment functionality and provide additional redundancy for emergency situations.

Controller 114 may send command signals to operate vehicle brakes (using brake sensor 116) via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”), a network inside modem vehicles used to control brakes, acceleration, steering, windshield wipers, and the like. The CAN bus may be configured to have dozens of nodes, each with its own unique identifier (CAN ID). The bus may be read to find steering wheel angle, ground speed, engine revolutions per minute (RPM), button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be provided with dedicated hardware and software, allowing control of throttle, brake, steering, and shifting. The hardware may provide a bridge between the vehicle's CAN bus and the controller 114, forwarding vehicle data to controller 114 including the turn signals, wheel speed, acceleration, pitch, roll, yaw, Global Positioning System (GPS) data, tire pressure, fuel level, sonar, brake torque, and others. Similar actuation controllers may be configured for any make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more radio detection and ranging (RADAR) sensors 126, one or more Light Detection and Ranging (“LIDAR”) sensors 128, one or more surround cameras 130 (typically such cameras are located at various places on vehicle body 104 to image areas all around the vehicle body), one or more cameras 132 (in an aspect, at least one such camera may face forward to provide object recognition in the vehicle's path), one or more infrared cameras 134, GPS unit 136 that provides location coordinates, a steering sensor 138 that detects the steering angle, speed sensors 140 (one for each of the wheels), an inertial sensor or inertial measurement unit (IMU) 142 that monitors movement of vehicle body 104 (this sensor may be, for example, an accelerometer(s) and/or a gyro-sensor(s) and/or a magnetic compass(es)), tire vibration sensors 144, and microphones 146 placed around and inside the vehicle. Other sensors may also be used.

Controller 114 may also receive inputs from an instrument cluster 148 and may provide human-perceptible outputs to a human operator via human-machine interface (HMI) display(s) 150, an audible annunciator, a loudspeaker and/or other means. In addition to traditional information such as velocity, time, and other well-known information, HMI display may provide the vehicle occupants with information regarding maps and vehicle's location, the location of other vehicles (including an occupancy grid) and even the controller's identification of objects and status. For example, HMI display 150 may alert the passenger when the controller has identified the presence of a water puddle, stop sign, caution sign, or changing traffic light and is taking appropriate action, giving the vehicle occupants peace of mind that the controller is functioning as intended. In an aspect, instrument cluster 148 may include a separate controller/processor configured to perform deep learning and AI functionality.

Autonomous vehicle 102 may collect data that is preferably used to help train and refine the neural networks used for autonomous driving. The autonomous vehicle 102 may include modem 152, preferably a system-on-a-chip (SoC) that provides modulation and demodulation functionality and allows the controller 114 to communicate over the wireless network 154. Modem 152 may include a radio frequency (RF) front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: long term evolution (LTE), wideband code division multiple access (WCDMA), universal mobile telecommunications framework (UMTS), global system for mobile communications (GSM), CDMA2000, or other known and widely used wireless protocols.

It should be noted that, compared to other sensors, cameras 130-134 may generate a richer set of features at a fraction of the cost. Thus, autonomous vehicle 102 may include a plurality of cameras 130-134, capturing images around the entire periphery of the autonomous vehicle 102. Camera type and lens selection depends on the nature and type of function. Autonomous vehicle 102 may have a mix of camera types and lenses to provide complete coverage around the autonomous vehicle 102; in general, narrow lenses do not have a wide field of view but can see farther. All cameras on autonomous vehicle 102 may support interfaces such as Gigabit Multimedia Serial link (GMSL) and Gigabit Ethernet.

In an aspect, cameras 130, 132 may include one or more monocular image sensors. Monocular image sensors tend to be ubiquitous, low cost, small, and low power, which makes such sensors desirable in a wide variety of applications such as vehicles, robots, drones, etc. In some examples, cameras 130, 132 may be responsible for capturing high-resolution images and processing them in real time. The output images of such camera-based systems may be used in applications such as depth estimation, object detection, object tracking, and/or pose detection, including the detection and recognition of static or moving objects, such as other vehicles, pedestrians, traffic signs, and lane markings. Cameras 130, 132 may be particularly good at capturing color and texture information, which is useful for accurate object recognition and classification.

Cameras 130, 132 may generally be any type of camera configured to capture video or image data in the environment around autonomous vehicle 102. For example, cameras 130, 132 may include a front facing camera (e.g., a front bumper camera, a front windshield camera, and/or a dashcam), a back facing camera (e.g., a backup camera), side facing cameras (e.g., cameras mounted in sideview mirrors), or surround cameras. Cameras 130, 132 may include color cameras or grayscale cameras. In some examples, cameras 130, 132 may include a camera system having more than one camera sensor.

In an aspect, a controller 114 may receive one or more images acquired by a plurality of cameras 130, 132. Controller 114 may include a portion of an ADAS to perform dynamic object tracking in accordance with the techniques of this disclosure. For example, controller 114 may be configured to receive a plurality of camera images generated by cameras 130, 132. Controller 114 may then perform improved dynamic object tracking processing using the camera output images according to the techniques described herein.

Although the techniques of this disclosure are described with respect to implementation in autonomous vehicle 102 (including ADAS), in other implementations the techniques may be used in drones, robots, ships, airplanes, helicopters, motorcycles, or other applications involving sensing of moving objects in a scene.

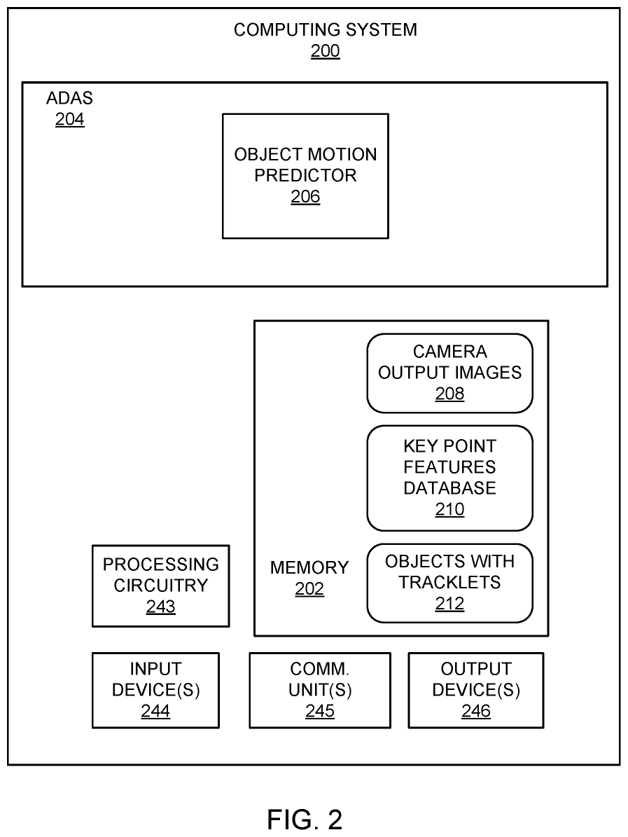

FIG. 2 is a block diagram illustrating an example computing system that may perform the techniques of this disclosure. As shown, computing system 200 comprises processing circuitry 243 and memory 202 for implementing ADAS 204, which may represent an example instance of any controller 114 described in this disclosure, such as controllers 114A, 114B, and 114C of FIG. 1.

In an aspect, ADAS 204 may include object motion predictor 206 to analyze a plurality of camera output images 208 generated by a plurality of cameras 130, 132 over time, determine key points in the camera output images, extract key features of the key points, store the key features in a key point features database 210, and determine objects with tracklets 212 represented by the key point features. In an aspect, a tracklet is a fragment of a track (e.g., describing movement in 3D space) by a moving object, as constructed by an image recognition system, such as ADAS 204.

Computing system 200 may be implemented as any suitable external computing system accessible by controller 114, such as one or more server computers, workstations, laptops, mainframes, appliances, embedded computing systems, cloud computing systems, High-Performance Computing (HPC) systems (i.e., supercomputing systems) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In an aspect, computing system 200 is disposed in vehicle 102.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure. Processing circuitry 243 may include one or more central processing units (CPUs), such as single-core or multi-core CPUs, graphics processing units (GPUs), digital signal processor (DSPs), neural processing unit (NPUs), multimedia processing units, and/or the like.

An NPU is a specialized circuit configured for implementing control and arithmetic logic for executing machine learning algorithms, such as algorithms for processing artificial neural networks (ANNs), DNNs, random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

In another example, computing system 200 comprises any suitable computing system having one or more computing devices, such as desktop computers, laptop computers, gaming consoles, smart televisions, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random-access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable read only memories (EPROM) or electrically erasable and programmable (EEPROM) read only memories.

Memory 202 may store program instructions and/or data associated with one or more of the modules described in accordance with one or more aspects of this disclosure. For example, memory 202 may store camera output images 208 received from cameras 130, 132, key point features database 210, and objects with tracklets 212, as well as instructions of ADAS 204, including object motion predictor 206.

Processing circuitry 243 and memory 202 may provide an operating environment or platform for one or more modules or units (e.g., ADAS 204, including object motion predictor 206, etc.), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute ADAS 204, including object motion predictor 206, using virtualization modules, such as a virtual machine or container executing on underlying hardware. One or more of such modules may execute as one or more services of an operating system or computing platform. Aspects of ADAS 204, including object motion predictor 206, may execute as one or more executable programs at an application layer of a computing platform.

One or more input device(s) 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output device(s) 246 may generate, transmit, or process output. Examples of output are tactile, audio, visual, and/or video output. Output devices 246 may include a display, sound card, video graphics adapter card, speaker, presence-sensitive screen, one or more universal serial bus (USB) interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, 5G and Wi-Fi® radios found in mobile devices as well as Universal Serial Bus (USB) controllers and the like.

In an aspect, object motion predictor 206 performs locality sensitive hashing (LSH) of points in camera output images 208 to aid in data clustering and generates 3D predictions of object motions. LSH is a known fuzzy hashing technique that hashes similar items into buckets where has collisions are maximized instead of minimized.

Self-attention (also called intra-attention) is an attention mechanism relating different positions of a single sequence to compute a representation of the same sequence. In self-attention processing, three sets of vectors are used: 1) queries (Q) of shape (N, D); 2) keys (K) of shape (N, D); and 3) values (V) of shape (N, D); where N is the number of points and D is the feature dimension. The attention is computed as shown in Equation 1.

Attention(Q,K,V)=softmax(QK^{T}/sqrt(D))*V; Equation 1
where T is time.

Computing QK^{T} includes a matrix multiplication between Q and K^{T}. This takes O(N²*D) time, since Q is (N, D) and K^{T} is (N, D). The softmax normalization takes O(N²) time. Finally, the multiplication by V takes O(N²*D) time. Overall, self-attention takes O(N²*D) time and O(N²) space due to an N×N attention matrix.

The core computation of self-attention is the determination of the QK^{T} attention matrix between all point pairs, which leads to the quadratic complexity in N. Due to the computational complexity of self-attention, as the number of points in a scene rises, system performance may suffer. Approximating or limiting this computation may lead to improved efficiency in dense tracking (e.g., tracking of large numbers of objects in a scene).

According to the techniques described herein, object motion predictor 206 may approximate the QK^{T} attention matrix using LSH, specifically LSH attention. The techniques described herein hash each point's query Q and key K vectors to hash buckets using LSH. The techniques only compute attention between points that hash to the same hash bucket. This reduces the complexity to O(ND+NS*D), where S is the hash bucket size (which may be selectable based at least in part on system performance goals). In this scheme, each point attends to S other points on average, rather than all N points. In this scenario, the attention operation is transformed to the operations of: hash each query qi and key kj to get hash buckets B(qi) and (Bkj) using LSH with hash functions h1, h2, . . . hL, where L is the number of hash functions. Then, the techniques only compute attention between queries qi and kj where B(qi)=B(kj).

In this case, Equation 1 may be transformed to Equation 2:

Attention−LSH(Q,K,V)=softmax(QB*KB^{T}/sqrt(D))*VB Equation 2
where B indexes the hash buckets and QB, KB, and VB select only the subsets of queries Q, keys K and values V that hash to the same hash buckets.

Equation 2 approximates the full attention with complexity O(ND+NS*D), where S may be controlled, enabling scaling to perform denser tracking of multiple objects. The accuracy of this approach may be tuned based on the quality of the hash functions h1, h2, . . . hL for capturing local neighborhoods of points.

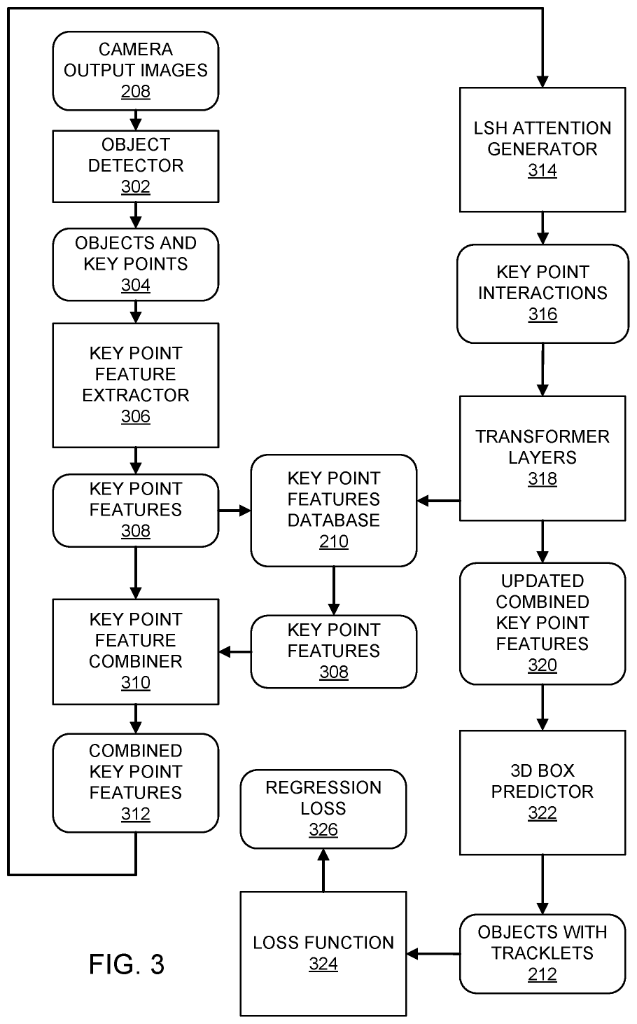

The techniques of the present disclosure extend LSH attention processing to determine detections and motion predictions for multiple 3D dynamic objects for a multi-camera system. FIG. 3 is a block diagram illustrating a system for performing object tracking in accordance with the techniques of this disclosure. In an aspect, FIG. 3 represents an instance of object motion predictor 206 of ADAS 204 of FIG. 2. Camera output images 208 are captured of a scene surrounding autonomous vehicle 102 by a plurality of cameras 130, 132. In an aspect, the camera output images 208 comprise a plurality of images over time (e.g., a video data stream) from the plurality of cameras 130, 132. Object detector 302 independently analyzes the camera output images of each camera view to determine initial objects and key points 304. In an aspect, object detector 302 implements a bird's eye view (BEV) fusion model such as “BEVFusion: A Simple and Robust LiDAR-Camera Fusion Framework” by Tingting Liang, et al., 36^{th} Conference on Neural Information Processing Systems (NeurIPS 2022), Nov. 11, 2022, although in other implementations other object detection processes may be used. In an aspect, objects are 3D objects of the scene and key points are two-dimensional (2D) points in the 3D objects. In an aspect, 3D objects may be represented as 3D bounding box detections {Bi^{c}} for each object i in each camera view c. For each detected 3D box Bi^{c}, object detector 302 samples four 2D key points {kj^{ic}} by projecting the eight corners of the 3D box Bi^{c} onto the image plane of camera c. This represents each object detection with four distinctive points.

Key point feature extractor 306 applies a convolutional neural network (CNN) (not shown in FIG. 3) to the key points to extract D-dimensional key point features 308 (which may be represented as fj^{ic}) for each key point. In an aspect, for each 2D key point kj^{ic}, key point extractor 306 extracts a D-dimensional vector fj^{ic} using a CNN backbone. This encodes the visual appearance of each key point. In an aspect, the CNN backbone may be as a residual neural network (ResNet). A ResNet is a deep learning model in which the weight layers learn residual functions with reference to the layer inputs. In other aspects, other CNNs may be implemented.

The term D of the D-dimensional vector fj^{ic} refers to the dimension of the feature vector that is extracted for each key point by the CNN backbone. The CNN backbone, such as ResNet, is used to extract a visual feature representation for each sampled 2D key point. This feature is configured to encode information about the appearance and context of the key point. D is a hyperparameter that determines the size/capacity of this feature vector. A higher value of D allows more expressive power, but also more parameters. Typical values used for D may include 64, 128, and 256 dimensions.

Key point features 308 may be stored in key point features database 210. In an aspect, key point features 308 may be stored in memory 202 of computing system 200, and memory 202 may comprise either volatile or non-volatile storage, either resident on autonomous vehicle 102 or accessible from a data center server over communication mechanisms described above. Key point features database 210 provides at least a read operation and a write operation. The read operation fetches long-term key point features for one or more selected key points, and the write operation updates the long-term key point features for one or more selected key points after transformer layers 318 processing (described below).

Object tracking processing with a windowed design approach may perform poorly when the scene includes very long temporal occlusions beyond the window size. Incorporating key point feature storage in memory of key points over long time periods helps to overcome the occlusion issue when longer time sequences of camera output images are available. Typically, window sizes are limited. Storing key point features database 210 in memory 202 allows for better object tracking in situations including occlusions and limited window sizes.

In the context of this disclosure, a “very long” temporal occlusion may be any occlusion that spans a duration of time longer than the window size being used, which is typically somewhere between 8-24 frames. Anything significantly longer than the window size (e.g., say 30+ frames) may be challenging for the windowed model to handle and could be characterized as a “very long” occlusion.

In an aspect, object motion predictor 206 stores key point features database 210 in a memory M belonging to the set R^{N*D} where N is the number of key points and D is the feature dimension. The memory stores long-term key point features mj^{ic} for each key point j of each object i in each camera view c. Key point feature combiner 310, for a given key point kj^{ic} identified as ej^{cg}, reads a long-term key point feature kj^{ic} from memory as mj^{ic}=M[index(kj^{ic})]. Thus, key point feature combiner 310 may read relevant features from key point features database 210 in memory 202 based at least in part on a key point index.

Key point combiner 310 obtains short term key point features 308 from the CNN model of key point feature extractor 306 and long-term key point features 308 from key point features database 210 and combines them to form combined key point features 312. In an aspect, key point combiner 310 concatenates the short term and long-term key point features 308 to form combined key point features 312. In an aspect, the features are combined as hj^{ic}=concat(fj^{ic}, mj^{ic}, ej^{ic}), where fj^{ic} is a short term key point feature, mj^{ic} is a long-term key point feature, and an embedding ej^{ic} represents an identifier (ID) of an object i and camera view c to which the key point belongs.

In the context of this disclosure, short-term key point features (fj^{ic}) refer to the features extracted from the current frame/window using the CNN backbone. Short-term key point features capture the most recent appearance of the key point. Long-term key point features (mj^{ic}) refer to the features stored in an external memory module. Long-term key point features accumulate information about the appearance of a key point and motion over a longer history spanning multiple frames/windows. In one example, short-term features have a temporal range of just the current frame/window (e.g., 8-24 frames). Long-term features have a longer temporal range, encompassing the accumulated history in the external memory spanning many frames/windows prior to the current frame. The memory allows incorporating context over an even longer term than what the windowed model can handle alone.

LSH attention generator 314 performs LSH attention processing on combined key point features 312 to model interactions between key points. LSH attention generator 314 applies LSH to hash key point features into hash buckets. This enables approximating attention between all pairs of key point features by only attending within each bucket as described above. Specifically, LSH attention generator 314 computes attention weights Ajkⁱc, i′c′ between key point features fj^{ic} and fk^{i′c′} that fall into the same hash bucket, thereby modeling key points interactions 316.

Transformer layers 318 applies transformer layers on top of the LSH attention to update combined key point features 312 to form updated combined key point features 320. In an aspect, this may be represented as h′ᵢ=transformer (h1). Transformer layers include a series of layers on top of LSH attention to update key point features hj^{ic} by modeling long-range dependencies between key points across objects and camera views. Transformer layers 318 may write updated key point features back to key point features database 210 (e.g., memory M[index(kj^{ic})]=hj^{ic}) based at least in part on the key point index. This allows the model to accumulate information about each key point's appearance and motion in long-term memory (e.g., key point features database 210 in memory 202)) and leverage this information during processing of occlusions longer than the window size. The memory may be trained end-to-end to capture useful long-term representations.

Transformer layers refer to the basic building blocks of the transformer architecture. Transform layers may include multi-head self-attention layers followed by feed-forward layers. In this model, the transformer layers are applied “on top of” the LSH attention mechanism. This means the transformer layers operate on the output of the LSH attention. More specifically, the LSH attention is used to generate attention weights between key point features within the same hash bucket. This models local interactions between key points. The output of the LSH attention is a set of combined key point features that incorporate information about neighboring key points via the attention.

The transformer layers then take these combined features as input. The transformer layers apply a transformer computation—multi-head attention followed by feed-forward layers. This allows the transformer to iteratively update the combined features by modeling long-range dependencies between key points across the entire scene/video, not just local neighborhoods. The updated features from each transformer layer incorporate more global context compared to the input features. Later transformer layers can incorporate information from earlier transformer layers via the residual connections in the architecture.

3D Box Predictor 322 analyzes updated combined key point features 320 (each of which may be represented as h′ᵢ) and predicts the 3D boxes with tracklets for each object (e.g., objects with tracklets 212). In an aspect, a 3D box includes eight vertices in a 3D coordinate system and each tracklet includes a vector of 3D points representing the tracked trajectory of an object over multiple frames. In some examples, a tracklet includes at least two 3D points, with each point corresponding to the detected/predicted 3D bounding box coordinates of an object in a single frame. A tracklet may be a vector where each element is the (x,y,z) coordinates of the 3D box detection for that object in a particular frame. For example, a simple 3-point tracklet could be: [[2,3,4], [4,5,6], [6,7,8]]. This represents the detected 3D box moving from coordinate (2,3,4) in one frame, to coordinate (4,5,6) in the next frame, and then to coordinate (6,7,8) in the third frame. Longer tracklets capture the trajectory over more frames.

3D box predictor 322 augments each updated combined key point feature hj^{ic} with an embedding ej^{ic} representing an ID of an object i and camera view c to which the key point belongs. In an aspect, 3D box predictor 322, for each object i, predicts an updated 3D box Bi^{c} by applying a multilayer perceptron (MLP) neural network (not shown in FIG. 3) over all key point features with the same object ID as object i.

In one example, the input to the MLP neural network is concatenated key point features for all key points belonging to the same object. As one example, there are K key points per object. The MLP neural network may further include hidden layers. The hidden layers may include a fully connected layer with rectified linear unit (ReLU) activation. The Input size is K*D and the output size is 128, where D is the feature dimension. The hidden layers may include another fully connected layer with ReLU activation, where the input size is 128 and the output size is 64. The output of the MLP neural network may include a fully connected layer that outputs a new feature vector of size D (e.g., same size as the input feature dimension).

A simple 3-layer MLP first projects the concatenated per-object features into a higher dimensional space (128), then reduces it back to a compact representation (64), before outputting a refined feature vector of the original size. The exact dimensions and number of layers could be tuned as hyperparameters. The goal is to model interactions between key points belonging to the same object to produce refined per-key point features.

After applying the transformer and MLP modules, the 3D box predictor 322 predicts a 3D bounding box Bi^{c} for each object i in each camera c. These predicted boxes comprise the “tracklet” for that object over the sequence of frames processed by the model window. During training, the model compares the predicted Bi^{c} to ground truth 3D boxes using a loss function like smooth L1 loss. This allows the model for 3D box predictor 322 to learn to refine its box predictions over multiple frames.

At test/inference time, the 3D box predictor 322 would process frames in a sliding window fashion (e.g., 8 frames at a time). 3D box predictor 322 predicts boxes Bi^{c} for each detected object over those frames to form a short tracklet segment. To extend the tracklets across longer videos, the predicted boxes from the end of one window would be used as input for the start of the next window. 3D box predictor 322 is configured to consistently predict the same object IDs and refine the boxes to smoothly connect tracklet segments. Post-processing like matching IDs, bounding box intersection-over-union, etc., could also be used to assemble the final long-term tracklets.

In an aspect, objects with tracklets 212 may be input to loss function 324 to compute a 3D box regression loss between the predicted and ground truth 3D boxes to train the object detection and tracking machine learning model in ADAS 204. The ground truth boxes may be obtained from annotations of the training video sequences. Typical datasets used for multi-object 3D tracking contain ground truth 3D bounding box annotations for each object in every frame. These annotations delineate the 3D position and orientation of the object's bounding box as it moves through the scene over time.

In an aspect, loss function 324 includes a L1 loss function to minimize the error, which is the sum of all absolute differences between the ground truth value and the predicted value Bi^{c}. During training, gradients may be allowed to flow back to memory M (e.g., key point features database 210). In general, the term gradients refers to using backpropagation to calculate how the loss changes with respect to the memory parameters in order to train the entire model end-to-end.

More specifically, the loss function (e.g., L1 loss) calculates the error between the predicted 3D boxes and the ground truth boxes. This loss value is then used in the backpropagation process during training. Backpropagation includes calculating the gradient of the loss with respect to each parameter in the model (e.g., weights of neural network layers, etc.). These gradients indicate how much changing each parameter would help reduce the loss. The model parameters are then updated in the direction that reduces loss, e.g., via an optimizer. Allowing gradients to flow back to memory M, means that during backpropagation and parameter updating he gradients are also calculated and used to update the parameters of the external memory module that stores the key point features. This helps train and refine the features stored in memory to ultimately improve the 3D box predictions and reduce loss.

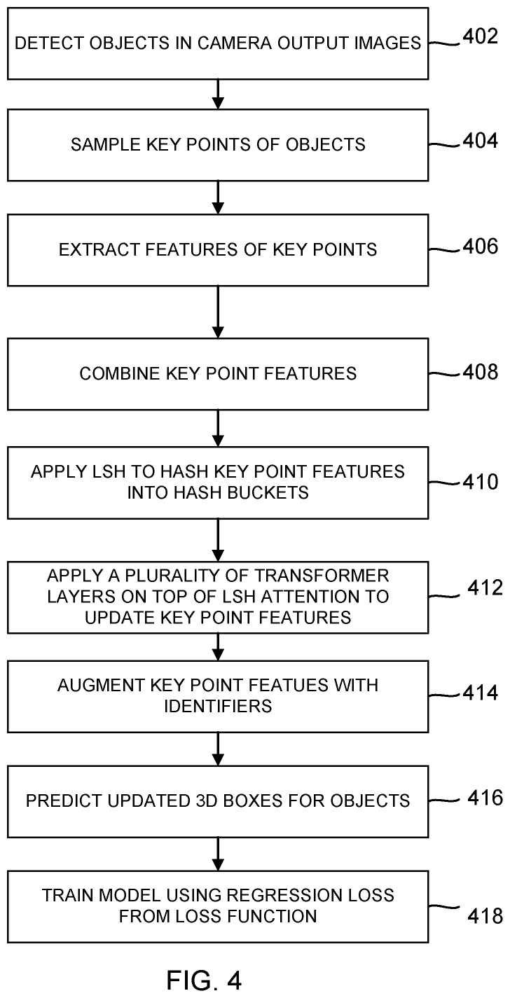

FIG. 4 is a flow diagram illustrating an example method for performing object tracking in accordance with the techniques of this disclosure. Although described with respect to computing system 200 (FIG. 2), it should be understood that other computing devices may be configured to perform a method similar to that of FIG. 4.

At block 402, object detector 302 detects objects in camera output images 208. At block 404, object detector 302 samples key points of objects detected at block 402. At block 406, key point feature extractor 306 extracts features of key points sampled at block 404. At block 408, key point feature combiner 310 combines short term key point features from block 406 and long-term key point features read from key point features database 210 in memory 202. At block 410, LSH attention generator 314 applies LSH attention processing to hash combined key point features 312 into hash buckets representing key point interactions 316. At block 412, transformer layers 318 apply a plurality of transformer layers on top of LSH attention to update combined key point features using key point interactions 316, represented as updated combined key point features 320 and stores the updated combined key point features in the key point features database as long-term key point features. At block 414, 3D box predictor 322 augments the key point features of updated combined key point features 320 with identifiers. At block 416, 3d box predictor 322 predicts updated 3D boxes for objects. The updated 3D boxes include tracklets representing motion of 3D dynamic objects in the scene over time. At block 418, the object motion predictor model may be trained using regression loss 326 from loss function 324.

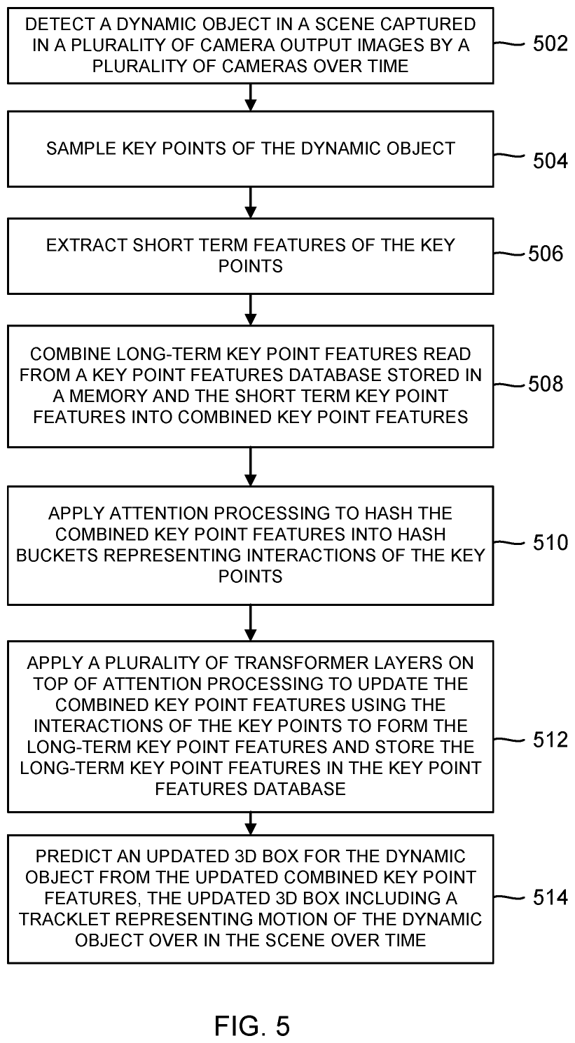

FIG. 5 is a flow diagram illustrating another example method for performing object tracking in accordance with the techniques of this disclosure. Although described with respect to computing system 200 (FIG. 2), it should be understood that other computing devices may be configured to perform a method similar to that of FIG. 5.

At block 502, the method includes detecting a dynamic object in a scene captured in a plurality of camera output images by a plurality of cameras over time.

At block 504, the method includes sampling key points of the dynamic object.

At block 506, the method includes extracting short term features of the key points.

At block 508, the method includes combining long-term key point features read from a key point features database stored in a memory and the short term key point features into combined key point features.

At block 510, the method includes applying attention processing to hash the combined key point features into hash buckets representing interactions of the key points.

At block 512, the method includes applying a plurality of transformer layers on top of attention processing to update the combined key point features using the interactions of the key points to form the long-term key point features and storing the long-term key point features in the key point features database.

At block 514, the method includes predicting an updated 3D box for the dynamic object from the updated combined key point features, the updated 3D box including a tracklet representing motion of the dynamic object in the scene over time.

The techniques described herein provide at least several advantages over prior approaches. The techniques handle long-term occlusions by using key point features database 210 in memory 202 to store long-term key point features 308, allowing for the model to handle occlusions beyond the current window size. This improves object tracking through long occlusions. The techniques leverage multiple camera views by integrating information across the multiple camera views thereby allowing the model to reconstruct and track objects in 3D space more robustly as compared to a system using a single camera view. The present system is computationally efficient due to the use of key point representations, LSH attention, and storage of key point features database 210 in memory 202, thereby making the model efficient for multi-object tracking. The techniques provide for flexible feature aggregation including concatenating short term and long-term identified key point features in memory to adaptively aggregate useful information from different sources. The techniques support end-to-end learning because the entire pipeline (including key point features database 210 in memory 202) can be trained end-to-end using the 3D loss to learn view aggregation. The techniques support generalizable representations due to storage of key point feature representations in memory that can be generalized across scenes and objects. The techniques are robust for processing complex motions because the transformer architecture captures complex inter-object and camera view dynamics and motions. Because the present system is modular, portions of the system may be improved independently, and extended to incorporate additional views, additional sensors (e.g., LiDAR sensors), and additional key points in a scalable manner. In sum, advantages of the present system include enhanced robustness to occlusions and complex motions, effective leveraging of multiple views, end-to-end learning of representations and view aggregation, and the modular and extensible pipeline architecture.

The following numbered clauses illustrate one or more aspects of the devices and techniques described in this disclosure.

Aspect 1. An apparatus for object tracking comprising: a memory; and one or more processors implemented in circuitry and in communication with the memory, the one or more processors configured to: detect a dynamic object in a scene captured in a plurality of camera output images by a plurality of cameras over time; sample key points of the dynamic object; extract short term features of the key points; combine long-term key point features read from a key point features database stored in a memory and the short term key point features into combined key point features; apply attention processing to hash the combined key point features into hash buckets representing interactions of the key points; apply a plurality of transformer layers on top of attention processing to update the combined key point features using the interactions of the key points to form the long-term key point features and storing the long-term key point features in the key point features database; and predict an updated 3D box for the dynamic object from the updated combined key point features, the updated 3D box including a tracklet representing motion of the dynamic object in the scene over time.

Aspect 2. The apparatus of Aspect 1, wherein the attention processing comprises locality sensitive hashing (LSH) attention processing.

Aspect 3. The apparatus of Aspect 2, wherein the LSH attention processing approximates a query-key attention matrix by hashing a query of a key point and key vectors to the hash buckets and computes attention only between queries hashing to a same hash bucket.

Aspect 4. The apparatus of any of Aspects 1-3, wherein to combine short term key point features and long-term key point features, the one or more processors are configured to concatenate the short term key point features and the long-term key point features.

Aspect 5. The apparatus of any of Aspects 1-4, wherein the one or more processors are further configured to: augment the updated combined key point features with identifiers.

Aspect 6. The apparatus of any of Aspects 1-5, wherein the one or more processors are further configured to: train a machine learning model for predicting object motion using a regression loss from a loss function applied to the updated 3D box including the tracklet.

Aspect 7. The apparatus of any of Aspects 1-6, wherein the one or more processors are further configured to: detect the dynamic object using a bird's eye view (BEV) fusion model.

Aspect 8. The apparatus of any of Aspects 1-7, wherein the one or more processors are further configured to: extract the key point features by a residual neural network.

Aspect 9. The apparatus of any of Aspects 1-8, wherein the one or more processors are further configured to: read long-term key point features from the key point features database based at least in part on a key point index.

Aspect 10. The apparatus of Aspect 9, wherein the one or more processors are further configured to: store the long-term key point features in the key point features database based at least in part on the key point index.

Aspect 11. The apparatus of any of Aspects 1-10, wherein the one or more processors are further configured to: predict the updated 3D box for the dynamic object, the updated 3D box including the tracklet, using a multilayer perceptron neural network.

Aspect 12. The apparatus of any of Aspects 1-11, wherein the apparatus comprises and vehicle, and wherein the plurality of cameras is disposed on the vehicle.

Aspect 13. A method of object tracking comprising: detecting a dynamic object in a scene captured in a plurality of camera output images by a plurality of cameras over time; sampling key points of the dynamic object; extracting short term features of the key points; combining long-term key point features read from a key point features database stored in a memory and the short term key point features into combined key point features; applying attention processing to hash the combined key point features into hash buckets representing interactions of the key points; applying a plurality of transformer layers on top of attention processing to update the combined key point features using the interactions of the key points to form the long-term key point features and storing the long-term key point features in the key point features database; and predicting an updated 3D box for the dynamic object from the updated combined key point features, the updated 3D box including a tracklet representing motion of the dynamic object in the scene over time.

Aspect 14. The method of Aspect 13, wherein the attention processing comprises locality sensitive hashing (LSH) attention processing.

Aspect 15. The method of Aspect 14, wherein the LSH attention processing approximates a query-key attention matrix by hashing a query of a key point query and key vectors to the hash buckets and computes attention only between queries hashing to a same hash bucket.

Aspect 16. The method of any of Aspects 13-15, wherein combining short term key point features and long-term key point features comprises concatenating the short term key point features and the long-term key point features.

Aspect 17. The method of any of Aspects 13-16, further comprising augmenting the updated combined key point features with identifiers.

Aspect 18. The method of any of Aspects 13-17, further comprising training a machine learning model for predicting object motion using a regression loss from a loss function applied to the updated 3D box including the tracklet.

Aspect 19. The method of any of Aspects 13-18, further comprising detecting the dynamic object using a bird's eye view (BEV) fusion model.

Aspect 20. The method of any of Aspects 13-19, further comprising predicting the updated 3D box for the dynamic object, the updated 3D box including the tracklet, using a multilayer perceptron neural network.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of random-access memory (RAM), read-only memory (ROM), electrically erasable ROM (EEPROM), compact disc ROM (CD-ROM) or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for object tracking comprising:
a memory; and
one or more processors implemented in circuitry and in communication with the memory, the one or more processors configured to:
detect a dynamic object in a scene captured in a plurality of camera output images by a plurality of cameras over time;
sample key points of the dynamic object;
extract short term features of the key points;
combine long-term key point features read from a key point features database stored in a memory and the short term key point features into combined key point features;
apply attention processing to hash the combined key point features into hash buckets representing interactions of the key points;
apply a plurality of transformer layers on top of attention processing to update the combined key point features using the interactions of the key points to form the long-term key point features and storing the long-term key point features in the key point features database; and
predict an updated 3D box for the dynamic object from the updated combined key point features, the updated 3D box including a tracklet representing motion of the dynamic object in the scene over time.

2. The apparatus of claim 1, wherein the attention processing comprises locality sensitive hashing (LSH) attention processing.

3. The apparatus of claim 2, wherein the LSH attention processing approximates a query-key attention matrix by hashing a query of a key point and key vectors to the hash buckets and computes attention only between queries hashing to a same hash bucket.

4. The apparatus of claim 1, wherein to combine short term key point features and long-term key point features, the one or more processors are configured to concatenate the short term key point features and the long-term key point features.

5. The apparatus of claim 1, wherein the one or more processors are further configured to:
augment the updated combined key point features with identifiers.

6. The apparatus of claim 1, wherein the one or more processors are further configured to:
train a machine learning model for predicting object motion using a regression loss from a loss function applied to the updated 3D box including the tracklet.

7. The apparatus of claim 1, wherein the one or more processors are further configured to:
detect the dynamic object using a bird's eye view (BEV) fusion model.

8. The apparatus of claim 1, wherein the one or more processors are further configured to:
extract the key point features by a residual neural network.

9. The apparatus of claim 1, wherein the one or more processors are further configured to:
read long-term key point features from the key point features database based at least in part on a key point index.

10. The apparatus of claim 9, wherein the one or more processors are further configured to:
store the long-term key point features in the key point features database based at least in part on the key point index.

11. The apparatus of claim 1, wherein the one or more processors are further configured to:
predict the updated 3D box for the dynamic object, the updated 3D box including the tracklet, using a multilayer perceptron neural network.

12. The apparatus of claim 1, wherein the apparatus comprises and vehicle, and wherein the plurality of cameras is disposed on the vehicle.

13. A method of object tracking comprising:
detecting a dynamic object in a scene captured in a plurality of camera output images by a plurality of cameras over time;
sampling key points of the dynamic object;
extracting short term features of the key points;
combining long-term key point features read from a key point features database stored in a memory and the short term key point features into combined key point features;
applying attention processing to hash the combined key point features into hash buckets representing interactions of the key points;
applying a plurality of transformer layers on top of attention processing to update the combined key point features using the interactions of the key points to form the long-term key point features and storing the long-term key point features in the key point features database; and
predicting an updated 3D box for the dynamic object from the updated combined key point features, the updated 3D box including a tracklet representing motion of the dynamic object in the scene over time.

14. The method of claim 13, wherein the attention processing comprises locality sensitive hashing (LSH) attention processing.

15. The method of claim 14, wherein the LSH attention processing approximates a query-key attention matrix by hashing a query of a key point query and key vectors to the hash buckets and computes attention only between queries hashing to a same hash bucket.

16. The method of claim 13, wherein combining short term key point features and long-term key point features comprises concatenating the short term key point features and the long-term key point features.

17. The method of claim 13, further comprising augmenting the updated combined key point features with identifiers.

18. The method of claim 13, further comprising training a machine learning model for predicting object motion using a regression loss from a loss function applied to the updated 3D box including the tracklet.

19. The method of claim 13, further comprising detecting the dynamic object using a bird's eye view (BEV) fusion model.

20. The method of claim 13, further comprising predicting the updated 3D box for the dynamic object, the updated 3D box including the tracklet, using a multilayer perceptron neural network.
